(19) United States
(12) Patent Application Publication
(10) Pub. No.: US 2013/0082127 A1
(43) Pub. Date: Apr. 4, 2013

(54) Closed-circuit grinding plant having an integrated buffer

(71) Applicant: Siegfried Strasser, Much (DE)

(72) Inventor: Siegfried Strasser, Much (DE)

(21) Appl. No.: 13/703,531

(22) PCT Filed: May 6, 2011
(86) PCT No.: PCT/EP11/57303

§ 371 Date: Dec. 11, 2012

(30) Foreign Application Priority Data
Jun. 16, 2010 (DE) 20 2010 009 150.0

(51) Int. Cl. B02C 23/00; B02C 23/10; B02C 23/02

(52) U.S. Cl. CPC B02C 23/00; B02C 23/02; B02C 23/10
USPC 241/24.1; 241/34

(57) ABSTRACT

A closed-circuit grinding plant for comminuting material to be ground, in which at least one comminution apparatus and at least one apparatus for separating comminuted material are connected to each other and keep the brittle material to be ground in the grinding circuit until it is removed from the grinding circuit by the separating device on account of the level of comminution, wherein a control loop controls the feed of fresh material to be ground into the circuit, and also relates to a corresponding method for operating such a closed-circuit grinding plant. A buffer for the material to be ground is present in the grinding circuit. The integration of the buffer enables a reduced overall height of the closed-circuit grinding plant, which saves energy costs. The filling level of the integrated buffer is suitable for controlling the closed-circuit grinding plant.

### BACKGROUND OF THE INVENTION

The invention relates to a closed-circuit grinding plant for comminuting brittle grinding stock, in which at least one comminuting apparatus and at least one apparatus for separating comminuted material are connected to one another and keep the brittle grinding stock in the grinding circuit until such time as it is removed from the grinding circuit by the separating apparatus on the basis of the level of comminution, wherein an intake of fresh grinding stock into the circuit is regulated by a control loop, and further relates to a thereto corresponding method for operating this closed-circuit grinding plant.

In closed-circuit grinding plants for comminuting brittle grinding stock, here, in particular, closed-circuit grinding plants of the kind which are intended for use to produce raw meal for the production of cement or for use to produce ground cement clinker, a dead volume of grinding stock, which is predefined by the size of the plant itself, is constantly found. Larger dead volumes are found, above all, in mechanical elevators, such as, for instance, a bucket elevator, but also in other units, such as, for instance, mills, roller presses, conveying elements and sifters.

For the maintenance or repair of such a closed-circuit grinding plant, it is necessary to empty the closed-circuit grinding plant in order to gain access to the individual units which are free from grinding stock. In normal operation, grinding stock, which is fed to the closed-circuit grinding plant in the uncomminuted state, leaves this exclusively in the finely ground state through the effect of a sifter. In order to empty the plant, it would seem obvious to keep the plant running and to halt the intake of fresh, uncomminuted material, in which state the closed-circuit grinding plant runs empty.

A closed-circuit grinding plant comprising roller presses cannot readily be run empty, for while this closed-circuit grinding plant is running it empties continuously through a sifter, wherein the quantity of the material found in the circuit steadily decreases and is gradually exhausted. Insofar as the material flow onto a roller press falls below a lower value, the comminution effect collapses because the roller press, under too small a load, displays no or insufficient comminution effect. In consequence, a sifter located in the closed-circuit grinding plant no longer sifts out any comminuted grinding stock and a thereby defined dead volume remains in the closed-circuit grinding plant.

In order to be able to run empty the closed-circuit grinding plants of this type, it was previously necessary to exhaust the dead volume, or else an external buffer, which can selectively be connected up to the grinding circuit, was attached to the system. Following the connection of the external buffer to the closed-circuit grinding plant, a bucket elevator, or other mechanical transport unit, located in the closed-circuit grinding plant empties into the external buffer, so that the closed-circuit grinding plant becomes empty. The material found in the external buffer remains in this case uncomminuted.

When the closed-circuit grinding plant is started up again, the external buffer, in a second configuration, is reconnected to the closed-circuit grinding plant, so that the external buffer can empty into the closed-circuit grinding plant.

In this type of emptying, the grinding stock is found either in the dead volume of the closed-circuit grinding plant or in the external buffer. Uncomminuted or only partially comminuted material is constantly present.

The apparatuses for selectively connecting the external buffer into the closed-circuit grinding plant are complex, expensive and fragile. The filling state of the buffer has to be individually checked prior to emptying of the closed-circuit grinding plant in order that the external buffer is not overfilled.

It would be desirable to design the closed-circuit grinding plant such that the external buffer can be dispensed with, or, at least, the complex connection and disconnection can be dispensed with.

### SUMMARY OF THE INVENTION

The object of the invention is therefore to provide a closed-circuit grinding plant which, without external buffer, can remove the grinding stock found in the dead volume of the closed-circuit grinding plant from the transport units of the closed-circuit grinding plant.

The inventive object is achieved by virtue of the fact that a buffer for grinding stock is present in the grinding circuit.

In order to operate the new closed-circuit grinding plant, a new operating method for the closed-circuit grinding plant is necessary. A further object associated with the first object of the invention is therefore to propose a method for operating the plant.

The second object is achieved by the use of a buffer for grinding stock in the grinding circuit, wherein the fill level of the buffer is integrated as a control variable in the control loop.

According to the invention, it is proposed not to use an external buffer to empty the material found in the dead volume, but rather a buffer which is present in the grinding circuit, i.e. is part of the grinding circuit. In order, by virtue of the buffer integrated in the grinding circuit, hereinafter referred to as the bunker, not to require further units for the filling and emptying, or in order not to increase the total height of the grinding circuit, it is necessary to integrate into the grinding circuit the site of the bunker at the location where there is sufficient fall height for the grinding stock found in the circuit. Since, in the design of closed-circuit grinding plants, overall height and free fall of grinding stock are as far as possible prevented in order to save energy costs for the circulatory transport, such locations in a closed-circuit grinding plant are rare. By modifying of the feed apparatus of a comminuting apparatus, here a roller press, it is possible, however, to continuously fill the bunker without the need for additional overall height. To this end, the feed apparatus for the roller press is designed as an overflow, wherein, as far as possible, only so much grinding stock per unit of time is fed to the feed apparatus that the fill level in the feed apparatus remains as far as possible constant. Slightly more grinding stock than necessary is supplied to the feed apparatus in order to keep the fill level of the feed apparatus constant. That grinding stock which is left over during maintenance of the fill level then runs in the feed apparatus through an overflow and falls from there, beside the roller press and a below-situated disagglomeration apparatus, into a bunker having a volume which is roughly as large as the dead volume of the closed-circuit grinding plant.

The bunker empties, for its part, either into the first sifter operating as a disagglomerator and situated beneath the roller press, or onto a conveyor belt which lies beneath the sifter operating as a disagglomerator. In the first case the bunker is disposed somewhat beneath or parallel to the roller press, and in the second case the bunker is disposed roughly at equal height to the sifter operating as a disagglomerator.

The use of the bunker integrated in the closed-circuit grinding plant and filled by an overflow of the feed apparatus has the advantage that the feed apparatus can hence be designed without a bunker. Without an own bunker, the feed apparatus requires less overall height, whereby the closed-circuit grinding plant has to lift the grinding stock found in the circuit over a lesser height. This saves energy costs for the maintenance of the grinding stock circulation.

Since the bunker acting as a buffer is embedded in the circuit and is not connected to the circuit from outside, the bunker is part of the control loop of the total plant.

### BRIEF DESCRIPTION OF THE DRAWINGS

The invention is explained in greater detail with reference to the following figure, wherein

FIG. 1: shows a diagram of an inventive closed-circuit grinding plant.

### DETAILED DESCRIPTION OF THE PREFERRED EMBODIMENTS

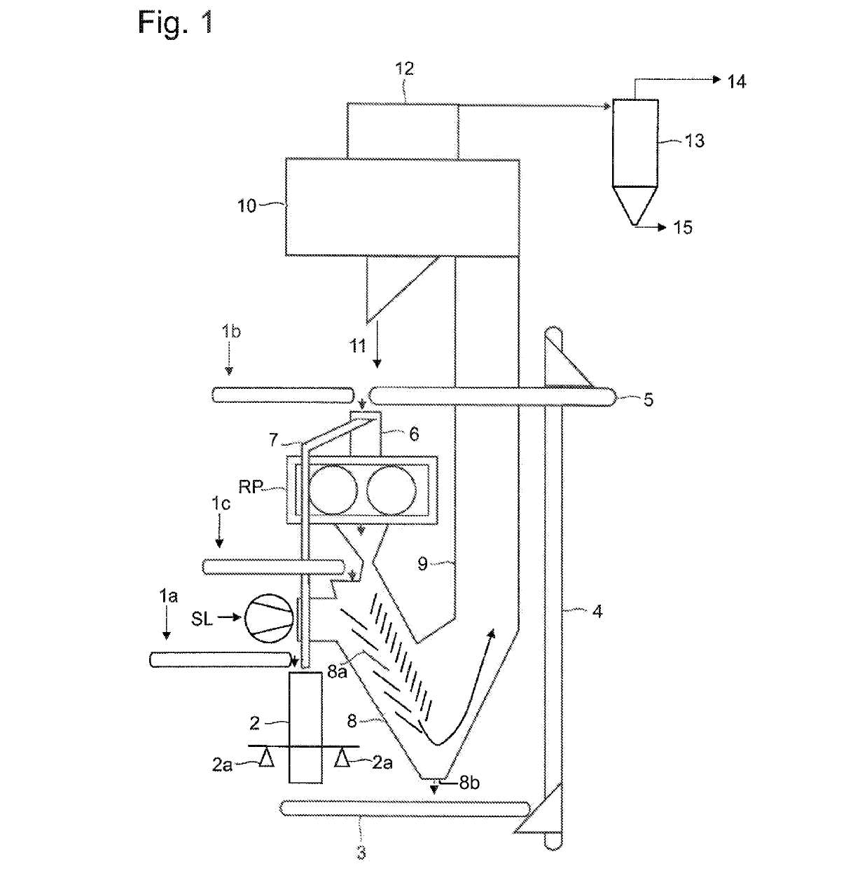

In FIG. 1, a diagram of an inventive closed-circuit grinding plant is represented. Grinding stock to be comminuted passes into the closed-circuit grinding plant via conveyor belts 1a, 1b or 1c. In the feed of the grinding stock with the conveyor belt 1a, the grinding stock is deposited into the bunker 2, in the feed of the grinding stock via the conveyor belt 1b, the grinding stock is deposited directly onto the feed apparatus 6 of the central roller press RP, and in the feed of the grinding stock via the conveyor belt 1c, the grinding stock is led into the V-sifter 8 acting as a disagglomerator. Each depositing site has different advantages. In the case of the feed onto the bunker 2, a control loop can be constructed such that the fill level of the bunker 2 is measured via a measuring apparatus, here via pressure capsules 2a, and the quantity of the fresh grinding stock which passes via the conveyor belt 1a into the closed-circuit grinding plant is regulated in dependence on the fill level of the bunker. The control system can regulate the speed and thus the transport capacity of the conveyor belt 1a in order constantly to keep the same quantity of grinding stock in circulation.

If the fresh grinding stock is fed via the conveyor belt 1b directly onto the feed apparatus 6 of the central roller press RP, then larger pieces of the grinding stock fall initially onto the gap of the roller press RP and are there first comminuted before they pass into the grinding circuit. As a result of the initial feed onto the roller press RP, the size distribution of the grinding stock in the roller press RP is altered in relation to the feed of the grinding stock at the other site and a, where necessary, narrower grain size distribution is thereby obtained.

Finally, the grinding stock can also be fed via the conveyor belt 1c into the grinding circuit, wherein the grinding stock fed by the conveyor belt 1c falls directly into the sifter 8 serving as a disagglomerator and there helps to disagglomerate the flakes of comminuted and agglomerated grinding stock which fall out of the central roller presses RP. Furthermore, the fine material contained in the fresh material is immediately sifted out and thus does not burden the roller press. Another advantage of the feed at this site is that the fresh material, which is generally still moist, is firstly subjected in the circuit to a preliminary drying. As a result of the preliminary drying, the efficiency of the sifters present in the circuit is promoted.

In the passage of the flakes through the sifter 8, these fall onto sifting plates 8a arranged in the manner of a staircase or blind, where they spontaneously, as a result of the impact, at least partially disintegrate. Sifting air SL, which is blown by a compressor into the V-sifter 8, pneumatically raises the light fraction of the grinding stock, which light fraction is freed from the flakes during the disagglomeration on the sifting plates 8a, in the vertical shaft 9 up to a second rod basket sifter 10. In the rod basket sifter 10, the very fine fraction of the comminuted grinding stock is separated from the light fraction of the comminuted grinding stock from the V-sifter 8 and leaves the rod basket sifter 10 via the sifter head 12 with a part of the sifting air SL. The fine fraction of the comminuted grinding stock, suspended in the sifting air SL, is then separated in a cyclone 13 from the sifting air SL and leaves the closed-circuit grinding plant at the outlet 15, whereas the blown-in sifting air SL leaves the closed-circuit grinding plant via the outlet 14. The fraction of the grinding stock which is rejected in the rod basket sifter 10 falls out of the outlet 11 and falls there into the feed apparatus 6 of the central roller press RP, where it combines with, where necessary, fresh grinding stock, which makes its way via the conveyor belt 1b into the closed-circuit grinding plant. At this location, the pneumatic circuit along the central roller press RP, the V-sifter 8, the pneumatic vertical duct 9 and the rod basket sifter 10 is completed.

In addition to this first, pneumatic circuit, a second, mechanical circuit exists in the closed-circuit grinding plant. This second, mechanical circuit separates from the above-described pneumatic circuit at the lower end of the V-sifter 8, where the heavy fraction, after the disagglomeration, leaves the V-sifter 8 downward through the outlet 8b. From the lower outlet 8b of the V-sifter 8, the grinding stock falls onto a conveyor belt 3, which conveys the heavy fraction to a bucket elevator 4 having a high dead volume. In the bucket elevator 4, the heavy fraction of the comminuted grinding stock is raised and at the upper end of the bucket elevator is deposited onto the conveyor belt 5, by which the heavy fraction of the comminuted grinding stock is re-fed onto the feed apparatus 6 of the central roller press RP and combines there with the fraction which has been rejected from the rod basket sifter 10.

The feed apparatus 6 of the central roller press RP is constructed such that it has an overflow 7. This overflow 7 leads the excess of grinding stock which is deposited on the feed apparatus 6 into the bunker 2, where a control apparatus, on the basis of the fill level of the bunker 2, regulates the quantity of the grinding stock introduced into the closed-circuit grinding plant. The bunker 2 discharges itself at its lower end onto the conveyor belt 3 or, in another configuration (not represented here), into the V-sifter 8.

Through the use of the bunker 2, it is possible to shorten the overall height of the feed apparatus 6 or to wholly dispense with a bunker above the feed apparatus. As a result of the reduction in the overall height of the feed apparatus, the necessary lifting height of the bucket elevator 4 is also reduced, wherein the reduced lifting height leads to considerable energy savings for the circulatory transport and the dead volume of the closed-circuit grinding plant is also thereby reduced.

According to the invention, an external buffer is integrated into the grinding circuit and is available there as an internal buffer for the grinding circuit. The design of the buffer is here less important. In the embodiment which is described here, the buffer is described as a bunker, which is filled from above with grinding stock and delivers grinding stock downward via an outlet. Any other form of a buffer which can be continuously charged with grinding stock and can also continuously deliver the same is also conceivable, however. The integration of the buffer allows a reduced overall height of the closed-circuit grinding plant, which saves energy costs. The fill level of the integrated buffer is suitable for the regulation of the closed-circuit grinding plant.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### LIST OF REFERENCE NUMBERS

1a conveyor belt

1b conveyor belt

1c conveyor belt

2 bunker

2a pressure capsules

3 conveyor belt

4 bucket elevator

5 conveyor belt

6 feed apparatus

7 overflow

8 V-sifter

8a sifting plates

8b outlet

9 vertical duct

10 rod basket sifter

11 outlet

12 sifter head

13 cyclone

14 outlet

15 outlet

RP roller press

SL sifting air

1-7. (canceled)

8. A closed-circuit grinding plant for comminuting brittle grinding stock, in which at least one comminuting apparatus and at least one apparatus for separating comminuted material are connected to one another and keep the brittle grinding stock in the grinding circuit until such time as it is removed from the grinding circuit by the separating apparatus on the basis of the level of comminution, wherein a control loop regulates the intake of fresh grinding stock into the circuit, comprising:
a buffer for grinding stock l0ocated in the grinding circuit, and
an overflow in the closed-circuit grinding plant for filling the buffer, wherein the overflow is part of a feed apparatus for the comminuting apparatus.

9. The closed-circuit grinding plant as defined in claim 8, wherein the fill level of the buffer is integrated as a control variable in the control loop.

10. The closed-circuit grinding plant as defined in claim 8, wherein the grinding circuit has more than one lifting step, wherein a first lifting step transports a first fraction of the brittle grinding stock pneumatically, and a second lifting step transports a second fraction of the brittle grinding stock mechanically.

11. The closed-circuit grinding plant as defined in claim 8, wherein fresh grinding stock flows into at least one of:
the feed apparatus of the comminuting apparatus,
the buffer, and
a disagglomeration apparatus, located in the circuit, of the closed-circuit grinding plant.

12. The closed-circuit grinding plant as defined in claim 8, wherein the buffer continuously receives grinding stock and continuously delivers grinding stock, wherein a fill level of the buffer is dependent on an intake of fresh grinding stock into the closed-circuit grinding plant.

13. A method for operating a closed-circuit grinding plant for comminuting brittle grinding stock, in which plant
at least one comminuting apparatus and
at least one separating apparatus for the separation of comminuted material
are connected to one another and keep the brittle grinding stock in the grinding circuit until such time as it is removed from the grinding circuit by the separating apparatus on the basis of the level of comminution, and
wherein an intake of fresh grinding stock into the circuit is regulated by a control loop, comprising the steps:
using a buffer for grinding stock in the grinding circuit,
integrating the fill level of the buffer as a control variable in the control loop' and
filling the buffer by an overflow, which overflow is part of a feed apparatus for the comminuting apparatus.
